(19) United States
(12) Patent Application Publication
(10) Pub. No.: US 2026/0367835 A1
(43) Pub. Date: Nov. 19, 2026

(54) TECHNIQUES FOR FILE-BASED DATA RELOCATION AT A MEMORY SYSTEM

(71) Applicant: Micron Technology, Inc., Boise, ID (US)

(72) Inventors: Hongyan Gou, Shanghai (CN); Jiayi Fu, Shanghai (CN)

(21) Appl. No.: 19/655,348

(22) Filed: Apr. 22, 2026

Related U.S. Application Data
(60) Provisional application No. 63/808,289, filed on May 19, 2025.

(51) Int. Cl. G06F 3/06

(52) U.S. Cl. CPC G06F 3/0659; G06F 3/0604; G06F 3/0673

(57) ABSTRACT

Methods, systems, and devices for techniques for file-based data relocation at a memory system are described. A system (e.g., a host system, a memory system) may select address regions to associate with a file-based relocation operation in accordance with a count of access operations performed in each address region of the memory system. In some cases, the address regions may be physical pointer table (PPT) regions, and may each include a set of consecutive addresses (e.g., logical addresses) organized in a corresponding PPT. The system may select regions in accordance with one or more criteria associated with the access operations performed in each region, including types of access operations performed in the region, a quantity of one or more types of access commands performed in the region, or a combination thereof. Such techniques may be implemented to recommend a region for a file-based optimization.

### CROSS REFERENCE

The present Application for Patent claims priority to U.S. Patent Application No. 63/808,289 by Gou et al., entitled “TECHNIQUES FOR FILE-BASED DATA RELOCATION AT A MEMORY SYSTEM,” filed May 19, 2025, which is assigned to the assignee hereof, and which is expressly incorporated by reference in its entirety herein.

### TECHNICAL FIELD

The following relates to one or more systems for memory, including techniques for file-based data relocation at a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for file-based data relocation at a memory system in accordance with examples as disclosed herein.

FIG. 2 shows an example of a system that supports techniques for file-based data relocation at a memory system in accordance with examples as disclosed herein.

FIGS. 3 and 4 show examples of processes that support techniques for file-based data relocation at a memory system in accordance with examples as disclosed herein.

FIG. 5 shows a block diagram of a memory system that supports techniques for file-based data relocation at a memory system in accordance with examples as disclosed herein.

FIG. 6 shows a block diagram of a host system that supports techniques for file-based data relocation at a memory system in accordance with examples as disclosed herein.

FIGS. 7-9 show flowcharts illustrating methods that support techniques for file-based data relocation at a memory system in accordance with examples as disclosed herein.

### DETAILED DESCRIPTION

In some cases, a memory system may become saturated (e.g., in accordance with a block saturation, associated with a queue being filled to capacity) if the memory system is commanded to support a high data throughput (e.g., of read data, of write date). In some cases, if saturated, data associated with a single file from a host system may be stored in non-sequential (e.g., non-contiguous) physical addresses of the memory system, even if the file is associated with sequential logical addresses (e.g., at the host system, at the memory system). For example, to write new data to a saturated memory system, non-sequential data may be replaced (e.g., overwritten), causing the new data to be written to non-sequential physical address. This may be referred to as “dirty” data, a “dirty” storage location, or unorganized data. Unorganized data within a memory system may increase latency for host access operations (e.g., read operations, write operations) at the memory system. For example, even if addresses (e.g., logical addresses) associated with access commands from a host system are sequential in a logical address domain, the physical addresses corresponding to the logical addresses may be non-sequential, causing a memory system to activate more access lines, more array portions (e.g., more blocks, more planes, more pages) or other components to access the unorganized data. Activating a relatively large quantity of access lines or other components may be associated with relatively high latency and power usage at a memory system. In some cases, the memory system may perform file-based optimization (FBO) (e.g., a file-based relocation operation, an FBO operation), for which the memory system may rewrite data within the memory system to different physical addresses and cause data associated with a single file (e.g., sequential logical addresses) to be written to sequential physical addresses (e.g., physical addresses associated in contiguous or neighboring access lines, physical addresses associated with a relatively lower quantity of blocks, planes, or pages). Thus, FBO operations may organize or clean one or more regions of a data space. In some cases, address region(s) of the memory system to reorganize using the FBO operation may be selected in accordance with a sequential or random order, and a memory system may perform FBO operations on regions that yield a relatively low improvement to performance if the memory system is saturated.

In accordance with techniques described herein, a system (e.g., a host system, a memory system, or a combination thereof) may select one or more regions (e.g., address regions) to associate with the FBO (e.g., to book to receive FBO operations, to add to an ordered FBO pool) in accordance with a counted quantity of access operations performed in each region (e.g., of multiple regions within the memory system). For example, a memory system may receive a set of commands to perform access operations on a set of addresses (e.g., logical addresses, corresponding to physical addresses at the memory system), and may determine respective quantities of the access operations that are performed (e.g., or to be performed) in respective regions associated with the memory system. In some cases, the regions of the memory system may be referred to as physical pointer table (PPT) regions, physical pointer regions, or address regions. Each region may include a set of consecutive (e.g., contiguous) logical addresses organized in a corresponding PPT (e.g., associated with a logical to physical address table). The PPT corresponding to a region may indicate a mapping between each logical address of the set of consecutive logical addresses and a physical address in the memory system. Further, each region may be associated with a tier (e.g., PPT1, PPT2, or PPT3) and may include one or more regions of a lower PPT tier (e.g., a PPT2 region may include one or more PPT3 regions). In some cases, the system may identify PPT2 regions to associate with the FBO.

The system may select one or more regions for FBO in accordance with one or more criteria associated with the access operations performed in each region. For example, the criteria may include one or more types of access operations performed in the region (e.g., read commands, write commands, unmap commands, erase commands), a quantity of one or more types of access commands performed in the region, or a combination thereof. In some examples, the system may transmit signaling to indicate or recommend the selected region for FBO, and an FBO may be performed on the region in response to receiving a recommendation of a region in accordance with the counted quantity of access operations performed in each region. By determining regions to associate with FBO based on access history in respective address regions, and indicating recommended regions to associate with FBO, a memory system may more quickly organize unorganized data if saturated, which may decrease latency and power usage for accessing files in the memory system.

In addition to applicability in memory systems as described herein, techniques for file-based data relocation at a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by determining regions within the memory system for FBO operations in accordance with access operations, which may reduce dirty or unorganized files (e.g., across physical memory cells) in high impact regions, improving read and access speeds in a memory system, among other benefits.

Features of the disclosure are illustrated and described in the context of systems, devices, and circuits. Features of the disclosure are further illustrated and described in the context of flowcharts and process flows.

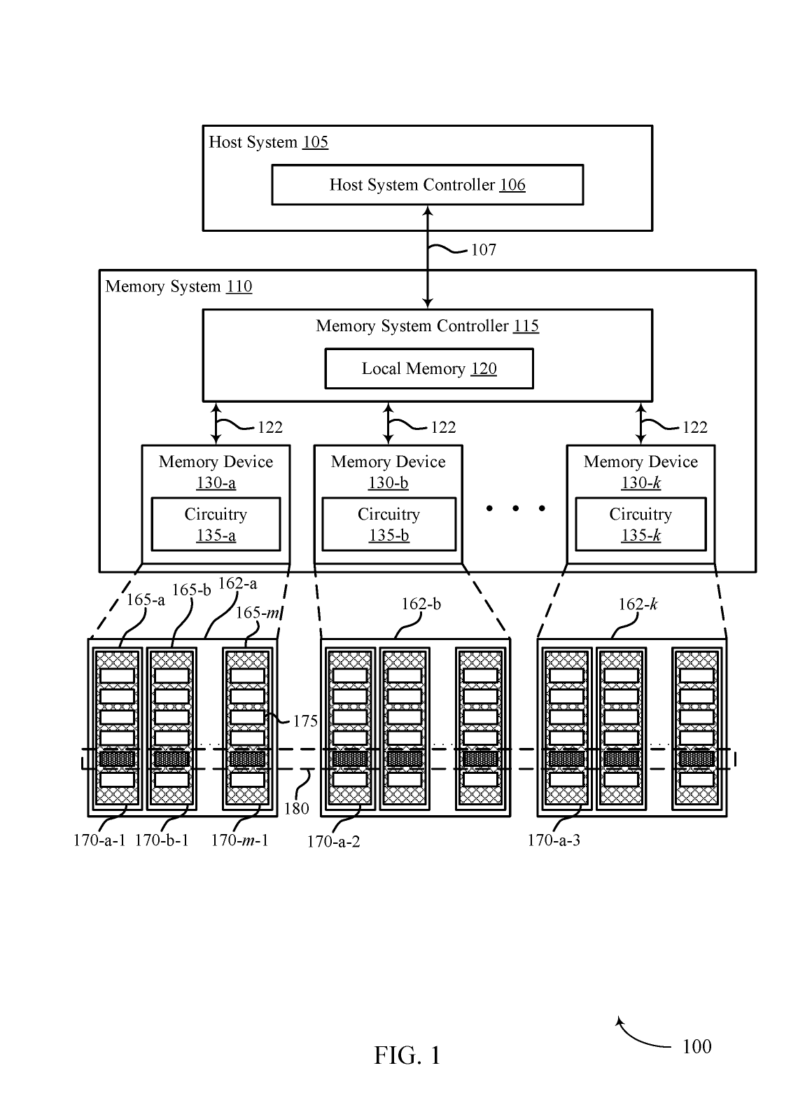

FIG. 1 shows an example of a system 100 that supports techniques for file-based data relocation at a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-k, where k represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-k may include circuitry 135-k.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include m planes 165 and each plane may include n blocks 170 (e.g., with the example of FIG. 1 illustrating one block 170 per plane 165), where m and n represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-m, where m represents an Mth plane. The memory die 162-b and the memory die 162-k may also include M planes. In some cases, an individual block 170 may be referred to as a physical block, and a virtual block 180 may refer to a group of blocks 170 within which concurrent operations may occur. A virtual block 180 may be a logical structure that includes a plurality of blocks 170, and different blocks 170 of the plurality of blocks 170 may come from different planes 165 or different memory dies 162. In some cases, a virtual block 180 may include blocks 170 from different memory devices 130 (e.g., including blocks in one or more planes 165 of memory device 130-a, memory device 130-b, and memory device 130-k). In some examples, a virtual block 180 may include a respective block 170 from each plane 165 (e.g., a block 170 from each plane 165) of one or more memory dies 162.

In some cases, the blocks 170 within a virtual block 180 may have the same block address within their respective planes 165. For example, block 170-a-1 may be “block 0” of a first plane 165 of die 162-a, block 170-a-2 may be “block 0” of a first plane 165 of die 162-b, block 170-a-3 may be “block 0” of a first plane 165 of die 162-k, and so on. By way of further example, block 170-b-1 may be “block 1” of a first plane 165 of die 162-a and block 170-m-1 may be “block m 1” of die 162-a, where m represents an Mth block. The memory die 162-b and the memory die 162-k may also include M blocks 170. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In accordance with techniques described herein, a system (e.g., a host system 105, a memory system 110) may select one or more regions (e.g., address regions) of a memory system 110 to associate with FBO (e.g., to book to receive FBO operations, to add to an ordered FBO pool or FBO queue) in accordance with a counted quantity of access operations performed in each region. For example, a memory system 110 (e.g., a memory system controller 115) may receive a set of commands to perform access operations on a set of addresses (e.g., logical addresses, which may correspond to physical addresses of one or more memory devices 130), and may determine respective quantities of the access operations that are performed (e.g., or to be performed) in respective regions. In some cases, the regions of the memory system 110 may be referred to as PPT regions, physical pointer regions, or address regions.

The system may select the one or more regions in accordance with one or more criteria associated with the access operations performed in each region. For example, the criteria may include one or more types of access operations performed in the region (e.g., read commands, write commands, unmap commands, erase commands), a quantity of one or more types of access commands performed in the region, or a combination thereof. In some examples, the system may transmit signaling to indicate or recommend the selected region for FBO, and may perform the FBO on the region in response to receiving a recommendation of a region in accordance with the counted quantity of access operations performed in each region. By determining regions to associate with FBO based on access history in respective address regions, and indicating recommended regions to associate with FBO, a memory system 110 (e.g., a memory system controller 115) may more quickly organize unorganized data if saturated, which may decrease latency and power usage for accessing files in one or more memory devices 130 of the memory system 110.

The system 100 may include any quantity of non-transitory computer readable media that support techniques for file-based data relocation at a memory system. For example, the host system 105 (e.g., a host system controller 106), the memory system 110 (e.g., a memory system controller 115), or a memory device 130 (e.g., a circuitry 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by circuitry 135), may cause the host system 105, the memory system 110, or the memory device 130 to perform associated functions as described herein.

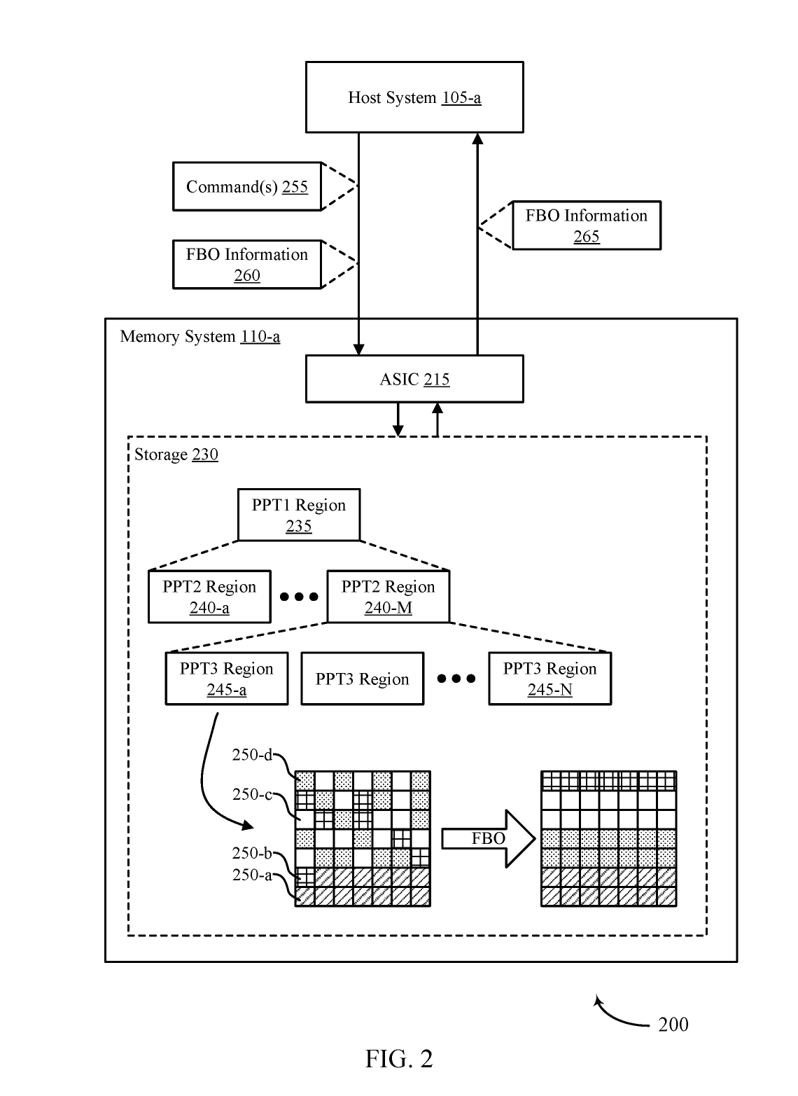

FIG. 2 shows an example of a system 200 that supports techniques for file-based data relocation at a memory system in accordance with examples as disclosed herein. In some cases, aspects of the system 200 may implement or be implemented by aspects of FIG. 1. For example, the system 200 may include a host system 105-a and a memory system 110-a (e.g., a single memory system 110, multiple memory systems 110). The memory system 110-a may include an ASIC 215, which may be an example of a memory system controller 115, and storage 230, which may refer to storage of local memory 120, one or more memory devices 130, or a combination thereof. In some aspects, the ASIC 215, the host system 105-a, or both, may determine a quantity of access operations from command(s) 255 that are performed in each of one or more regions of the storage 230 (e.g., PPT2 regions 240, PPT3 regions 245, regions of an address mapping of the memory system 110-a), and the memory system 110-a may perform an FBO associated with one or more regions of the storage 230 in accordance with the determined quantities of access operations.

In some cases, the memory system 110-a may be a UFS device or may include one or more UFS devices that include the storage 230 (e.g., memory storage). A UFS device may be a mass storage device with a serial interface, and may be used, for example, in mobile systems including host processing and mass storage memory devices. For example, digital cameras, mobile phones, and consumer electronics may include UFS devices such as the memory system 110-a. A UFS device may use an M-PHY interface for access, which may provide relatively high access speed, relative ease of integration into embedded application, and relatively low power consumption. In some cases, UFS devices may use an SCSI architectural model.

In some cases, the storage 230 of the memory system 110-a may include one or more regions, such as PPT1 region(s) 235, PPT2 regions 240, and PPT3 regions 245, which each may include a set of contiguous addresses (e.g., logical addresses) mapped to the storage 230. In some cases, a performance (e.g., random write performance) of the memory system 110-a may be improved by using a page-based L2P table to map logical addresses used by the host system 105-a to physical addresses 250 in the storage 230 (e.g., physical addresses of one or more memory devices 130), but a single L2P table for the entire storage 230 may increase latency to access and use the L2P table. For example, a size of the L2P table may increase linearly with an increased storage capacity of the storage 230, which may utilize large amounts of RAM in the ASIC 215 (e.g., relatively large amounts of local memory 120). Accordingly, each region of the storage 230 may be associated with one or more PPTs (e.g., physical pointer tables), which may be used in a similar manner as an L2P table. For example, each PPT may include entries that map logical addresses in a PPT region to physical addresses 250 of the storage 230. Relatively small PPTs may reduce the amount of RAM used at the ASIC 215 to access memory in the storage 230 and may increase access speeds of the storage 230.

Each region (e.g., physical pointer region, address region) of the storage 230 may correspond to a tier, and each tier may correspond to a size of a PPT. For example, PPT1 regions 235 may correspond to a largest PPT, where a PPT1 region 235 may be a memory device (e.g., the memory devices 130), a set of memory devices, a section of a memory device, or any combination thereof. A region of a higher tier (e.g., tier 1, PPT1) may include a set of one or more regions of a smaller tier (e.g., tier2, PPT2). For example, the PPT1 region 235 may include M PPT2 regions, including PPT2 region 240-a through PPT2 region 240-M. Further, each PPT2 region 240 may include one or more PPT3 regions, such as PPT2 region 240-M including N PPT3 regions, PPT3 region 245-a through PPT3 region 245-N. Although the system 200 shows the PPT3 regions as a lowest (e.g., smallest) tier of PPT, smaller tiers may be used in some other examples of storage 230. In some cases, the PPT3 regions 245 may refer to a set of physical addresses 250 (e.g., one or more blocks 170) and, in some examples each physical address 250 may represent a page 175. In an illustrative example, the PPT1 region 235 may include 128 PPT2 regions 240, each PPT2 region 240 may include 1024 PPT3 regions 245, and each PPT3 region 245 may include 1024 pages 175 (e.g., of physical addresses), for which a page 175 may be associated with a capacity of 4KB.

In some cases, the memory system 110-a may become saturated, which may be associated with a threshold quantity of the physical addresses 250 being used to store data. In some cases, performance (e.g., speed, error correction, power usage) of the memory system 110-a (e.g., read performance, write performance) may degrade after saturation of the memory system 110-a. For example, saturation of the memory system 110-a may cause the memory system 110-a to write or move data to non-contiguous physical addresses 250, which may be physical addresses 250 that are not associated with a same access line (e.g., word line). For examples in which data associated with one or more files is stored in non-sequential physical addresses 250 (e.g., shown in PPT3 region 245-a before the FBO), the data may be unorganized (e.g., dirty). For example, a region in the storage 230 (e.g., PPT3 region 245-a) may include data from multiple files, such that a physical address 250-a may store data of a first file, physical address 250-b may store data of a second file, physical address 250-d may store data of a third file, and physical address 250-c may be empty (e.g., not storing data, storing invalid data or data not mapped to a logical address). That is, PPT3 region 245-a may be unorganized or dirty.

In some cases, the memory system 110-a (e.g., a UFS device) may utilize FBO (e.g., a relocation operation) as one interface to reduce performance degradation after saturation. In some cases, the FBO may be a function of file base information (e.g., file system information) transferred to the UFS device (e.g., from the host system 105-a). For example, the host system 105-a may provide the memory system 110-a with file base information, including logical addresses of data associated with corresponding files, sizes of files stored in the memory system 110-a, or other information. In some cases, a file may include a digital object such as a digital document, an image, a video, or other information stored digitally. Performing FBO may include rewriting unorganized data in the storage 230 such that the data for at least one file may be in consecutive physical addresses 250. For example, during an FBO, the memory system 110-a may write data associated with sequential (e.g., continuous) logical addresses to sequential (e.g., continuous) physical addresses 250. In some cases, FBO may be performed on a region basis, such that FBO may make consecutive the physical addresses associated with a region of logical addresses of the storage 230. For example, the memory system 110-a may perform an FBO on (e.g., associated with, for) the PPT2 region 240-M to rewrite data of files that are stored in the PPT3 regions 245 of the PPT2 region 240-M to be in consecutive physical addresses. In some cases, during rewriting of data for an FBO, the data for each file may come from or be rewritten to a same or different region from the region on which the FBO is performed. Such organized data may be illustrated in the PPT3 region 245-b after the FBO.

In some cases, the host system 105-a or the memory system 110-a may trigger an FBO in response to decreased performance of the memory system 110-a. For example, the memory system 110-a may receive and analyze file base information from the host system 105-a, and may provide the host system 105-a with an indication of a regression in performance in accordance with the file base information. For example, if the memory system 110-a determines, using the file base information, that data associated with the files of the host system 105-a are stored in an unorganized or dirty fashion among physical addresses 250 within the storage 230, the memory system 110-a may estimate an effect of the unorganized data on the performance (e.g., access speed, power usage, other memory metric) of the memory system 110-a, and may indicate the estimated effect to the host system 105-a. If the effect of the unorganized data satisfies a threshold (e.g., or the performance of the memory system 110-a fails to satisfy a threshold), the host system 105-a may command the memory system 110-a to perform FBO within the storage 230 to improve the performance. Additionally, or alternatively, the host system 105-a may determine a threshold level of performance of the memory system 110-a and may configure the memory system 110-a with the threshold (e.g., bFBOExecuteThreshold), such that the memory system 110-a may automatically perform FBO, for example, as a background operation or if the memory system 110-a enters an idle state. The host system 105-a may also command the memory system 110-a to perform FBO by setting a control attribute (bFBOcontrol), such that the memory system 110-a may perform FBO in accordance with one or both of the threshold and the control attribute. For example, the memory system 110-a may perform the FBO if the effect of the unorganized data is above the threshold (e.g., or the performance is below the threshold) and the host system 105-a commands to perform the FBO by setting the control attribute. Additionally, or alternatively, the host system 105-a may transmit a get attribute (bFBOProgressState) to the memory system 110-a to check a progress of the analysis of the file base information, a progress of the FBO, or both.

In some cases, however, particular regions on which to perform FBO may be selected in a way that reduces the utility of FBO. For example, if FBO is performed on a PPT2 region 240 with data that is largely organized, performance of the memory system 110-a may experience a relatively small improvement. In some cases, the memory system 110-a may select regions randomly or in a sequential order to associate with (e.g., book for) the FBO, but such designs may take a long time to perform FBO on regions that are most unorganized. Thus, techniques for determining regions for FBO and performing FBO on the determined regions may improve performance at the memory system 110-a.

In accordance with techniques described herein, the memory system 110-a, the host system 105-a, or both, may determine which regions to associate with the FBO in accordance with an access history on respective regions, which may increase performance of the memory system 110-a more quickly and efficiently. In some cases, the memory system 110-a may detect regions for FBO and initiate FBO on the regions as background operations or if the memory system 110-a is in an idle mode. In some cases, the memory system 110-a may indicate, to the host system 105-a, an FBO recommendation flag and one or more recommended regions for FBO during an active, idle, or background operations duration, and the host system 105-a may initiate FBO in accordance with the FBO recommendation flag. Additionally, or alternatively, the host system 105-a may determine one or more regions and initiate FBO on the one or more regions to improve the effectiveness of the FBO. In some cases, the memory system 110-a, the host system 105-a or both may use a machine learning (ML) model to dynamically and automatically determine regions for FBO. For example, in accordance with access operation data collected over various periods of time (e.g., each day, each hour, each week), the ML model may forecast user behavior of usage for various region, and the memory system 110-a or host system 105-a may determine regions on which to perform FBO (e.g., while the memory system 110-a is idle).

In some cases, a device (e.g., the memory system 110-a, the host system 105-a) of the system 200 may be configured to follow an algorithm to determine the regions for FBO. In some examples, the device may identify (e.g., determine, be configured with parameters indicating) regions of the storage 230. For example, the device may identify a quantity of physical blocks (e.g., blocks 170) in each PPT3 region 245, a quantity of PPT3 regions 245 in each PPT2 region 240, and a quantity of PPT2 regions 240 in each PPT1 region.

In some examples, the device may determine one or more parameters associated with a set of commands 255 and the regions of the storage 230. For example, the one or more parameters may include a quantity of access operations from the set of commands 255 that occur in each of the PPT2 regions 240 (e.g., a hit count for each PPT2 region 240) and a scatter factor for each PPT2 region 240. For example, each command 255 may indicate one or more logical addresses, such as X, on which to perform the command 255. The logical addresses associated with the storage 230 may be split into consecutive PPT3 regions 245, where each PPT3 region 245 may include Y sequential logical addresses. Thus, a number (e.g., identifier) of a PPT3 region 245 in which an access operation is performed may be the integer of the quotient X divided by Y (e.g., int(X/Y)). For example, if an access operation is performed on a logical address 100000 and each PPT3 region includes a set of 1024 logical addresses, the integer of the quotient 100000 divided by 1024 is 96, meaning that the access operation was performed on the 96th PPT3 region 245. The device may determine in which PPT2 region 240 the access operation was performed by a similar method, such as dividing the number of the PPT3 region in which the access operation was performed by a quantity of PPT3 regions within each PPT2 regions. For example, if there are 1024 PPT3 regions 245 in each PPT2 region 240, the integer of 96 divided by 1024 may be 0, meaning that the access operation was performed in the 0th (e.g., first) PPT2 region 240.

Thus, in accordance with these and other examples, from a set of access operations associated with a set of commands 255, the device may determine respective quantities of the access operations performed in each PPT3 region 245 and in each PPT2 region 240, as well as a quantity of different PPT3 regions 245, PPT2 regions 240, or both, that received access operations. The device may determine also determine a region scatter factor for the storage 230, which may be a ratio of the quantity of PPT2 regions 240 within which access operation were performed to a total quantity of access operations performed. For example, if the ratio is relatively low (e.g., lots of operations were performed in few PPT2 regions 240), the data in the accessed PPT2 regions 240 may be more unorganized than if the ratio is relatively high (e.g., fewer operations performed in many PPT2 regions 240).

In some examples, the device may determine a type of each access operation and a quantity of each type of access operation that occurs in each region. For example, the device may count read operations, write operations, unmap operations, erase operations, or one or more other types of operations, that occur in each PPT2 region 240 and PPT3 region 245. The device may also determine quantities of PPT2 regions 240 that received each type of access operations.

Based on such techniques, the device may use the determined parameters to identify a region for FBO. For example, the device may apply one or more criteria to the parameters to determine one or more PPT2 regions to associated with the FBO (e.g., to place in an FBO queue, to place in an ordered FBO pool, to book for FBO). In some cases, a first criteria may be to have received a threshold quantity (e.g., at least 1) of each type of access operation of a set of access operations. For example, a PPT2 region 240 may satisfy the first criteria if a read operation, a write operation, and an unmap operation occurred within the PPT2 region 240. A second criteria may be to have received a threshold quantity of read operations. For example, a PPT2 region 240 may satisfy the second criteria if a quantity read operations (e.g., per quantity of commands) performed within the PPT2 region 240 satisfies a threshold quantity. A third criteria may be to have received a threshold quantity of combined write and unmap operations. For example, a PPT2 region 240 may satisfy the second criteria if a sum total of write operations and unmap operations (e.g., per quantity of commands) performed within the PPT2 region 240 satisfies a threshold quantity.

In some cases, one or more of the PPT2 regions 240 that satisfy any one or more of the criteria may be selected by the device to associate with the FBO. For example, the device may select all PPT2 regions 240 that satisfy any one or more of the criteria to associate with the FBO. Additionally, or alternatively, the device may pick up to a threshold quantity (e.g., up to 3) of PPT2 regions 240 that satisfy any one or more of the criteria. In some cases, the criteria may be prioritized, such that if more than the threshold quantity of PPT2 regions 240 satisfy one or more criteria, PPT2 regions 240 that satisfy criteria associated with a higher priority may be selected first. In some cases, if more than the threshold quantity of PPT2 regions 240 satisfy a same criteria, the device may use the region scatter factor, a saturation level, a history of selected PPT2 regions 240, or another parameter of the regions to determine one or more regions to associate with the FBO.

After determining one or more regions to associate with the FBO, the device may perform one or more actions to effectuate FBO on the determined regions. For example, if the device is the memory system 110-a, the memory system may transmit FBO information 265 to the host system 105-a. The FBO information 265 may indicate one or more of an FBO recommendation flag, an urgency level associated with performing FBO, and the one or more regions to the host system 105-a. For example, the urgency level may be associated with the region scatter factor, the total quantity of access operations, the file base information, or another factor described herein. In response to the FBO recommendation flag, the urgency level, and the indicated regions, the host system 105-a may command the memory system 110-a to perform the FBO on the indicated regions (e.g., along with one or more other region, during an active time, instead of one or more other regions). Additionally, or alternatively, if the memory system 110-a does not transmit the FBO information 265 or does not receive a command from the host system 105-a to perform FBO, the memory system 110-a may perform FBO on the determined regions as a background operation or during an idle time of the memory system 110-a.

In some other examples, if the device is the host system 105-a, the host system may transmit FBO information 260 to the memory system 110-a. For example, the FBO information 260 may indicate a region scatter factor associated with one or more regions, the determined regions for FBO, an urgency level, a command to perform FBO on the determined regions (e.g., determined by the host system 105-a, the memory system 110-a, or both), or any combination thereof. In response to receiving the FBO information from the host system 105-a, the memory system 110-a may perform FBO.

Thus, in accordance with these and other examples, the system 200 may be configured to select region on which to perform FBO in an intelligent manner, which may increase an improvement to performance achieved by the FBO.

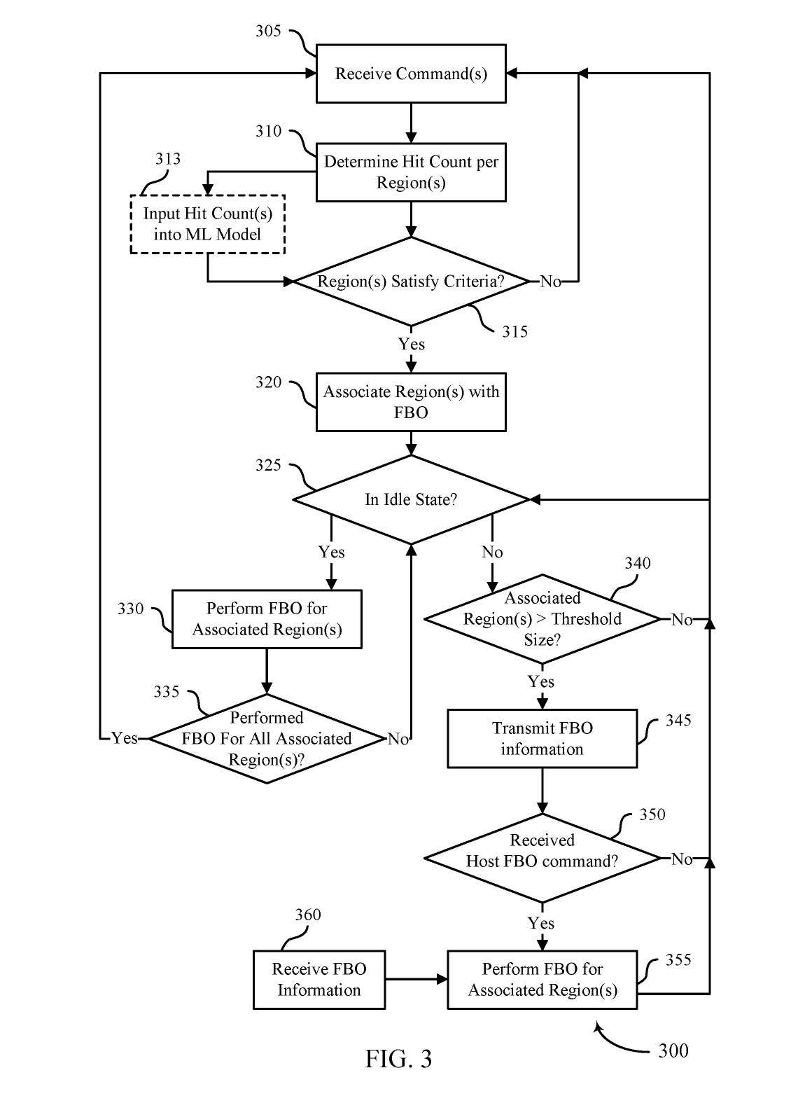

FIG. 3 shows an example of a process 300 that supports techniques for file-based data relocation at a memory system in accordance with examples as disclosed herein. In some cases, aspects of the process 300 may implement or be implemented by aspects of FIGS. 1 and 2. For example, the process 300 may be performed by a memory system 110, a memory system controller 115, an ASIC 215, or another component of the systems 100 and 200. In some aspects, the process 300 may illustrate an example algorithm that a memory system may perform to determine regions to book for FBO.

In the following description of the process 300, the operations may be performed in a different order than the order shown, or other operations may be added or removed from the process 300. For example, some operations may be left out of process 300, may be performed in different orders or at different times, or other operations may be added to process 300. Although a memory system may perform the operations of process 300, some aspects of some operations may also be performed by one or more other devices or components of the systems 100 and 200. Aspects of the process 300 may be implemented by one or more controllers, among other components. Additionally, or alternatively, aspects of the process 300 may be implemented as instructions stored in one or more memories (e.g., firmware stored in one or more memories coupled with a memory system). For example, the instructions, when executed by one or more controllers (e.g., a memory system controller 115, an ASIC 215), may cause the one or more controllers (or a device or a system) to perform the operations of the process 300.

At 305, one or more commands (e.g., commands 255) may be received. For example, the memory system 110 may receive (e.g., from a host system 105) one or more commands for access operations on multiple addresses (e.g., logical addresses, associated with physical addresses of one or more memory devices 130) of the memory system 110. In some cases, an ASIC 215, a memory system controller 115, a NAND controller, or other circuitry of the memory system 110 may receive the one or more commands. The access operations may include one or more of write operations, read operations, and unmap operations, as well as other types of access operations.

At 310, respective quantities (e.g., hit counts) of the access operations performed in each of one or more address regions (e.g., PPT regions, such as PPT2 regions 240 and PPT3 regions 245) may be determined. For example, the memory system 110 may determine, for each address region of multiple address regions of the memory system, a respective quantity of the access operations performed in the address region. In some cases, the ASIC 215, the memory system controller 115, the NAND controller, or other circuitry of the memory system 110 may determine the respective quantities. For example, the memory system 110 may determine a first quantity of read operations, a second quantity of write operations, and a third quantity of unmap operations performed within each address region. In some cases, the memory system 110 may store an indication of the respective quantities in a table.

In some cases, the memory system 110 may (e.g., alternatively) receive an indication of the respective quantities of the access operations performed in each address region. For example, a host system 105 (e.g., a host system controller 106) may determine the respective quantities of the access operations and indicate the respective quantities to the memory system 110 via a command or other signaling.

At 313, the respective quantity of the access operations determined for each address region may be inputted into an ML model. For example, the memory system 110 may input the respective quantities into the ML model that is associated with a file-based relocation operation (e.g., FBO). In some cases, the ASIC 215, the memory system controller 115, the NAND controller, or other circuitry of the memory system 110 may input the respective quantities into the ML model. In some cases, the memory system 110 may input the respective quantities into the ML model once per period of time, such as once an hour, once a day, or a different period. Additionally, or alternatively, the memory system 110 may input the respective quantities into the ML model after receiving a threshold quantity of commands. In some cases, the ML model may be trained to identify patterns and predict quantities of access operations performed during the period of time or quantity of commands in one or more regions.

At 315, whether one or more regions satisfy one or more criteria may be determined. For example, the memory system 110 may determine if one or more of the regions satisfy a criteria of a set of criteria. In some cases, the ASIC 215, the memory system controller 115, the NAND controller, or other circuitry of the memory system 110 may determine whether one or more regions satisfy one or more of the criteria. For example, a region may satisfy a first criteria if each of a first quantity of read operations, a second quantity of write operations, and a third quantity of unmap operations performed within the region satisfy a threshold. Additionally, or alternatively, a region may satisfy a second criteria if a quantity of read operations of the respective quantity of the access operations performed in the region satisfy a threshold. Additionally, or alternatively, a region may satisfy a first criteria if a combined quantity of write operations and unmap operations of the respective quantity of the access operations performed in the region satisfy a threshold. The memory system 110 may determine and apply one or more other criteria to the respective quantities of the access operations.

At 320, a set of regions (e.g., address regions) associated with the plurality of commands may be determined and associated with the FBO. For example, the memory system 110 may determine the set of regions. In some cases, the ASIC 215, the memory system controller 115, the NAND controller, or other circuitry of the memory system 110 may determine the set of regions. In some cases, the set of address regions is determined in accordance with the respective quantities of the access operations determined for each address region, whether the respective quantities are determined at the memory system or received from another device (e.g., the host system 105). Additionally, or alternatively, a region may be selected and associated with the FBO in accordance with an output of the machine learning model. In some cases, a region may be selected in response to satisfying any one of the criteria described herein. Additionally, or alternatively, the set may be of a threshold quantity of regions, and the regions may be selected in accordance with a priority of the criteria and a region scatter factor, as described herein with reference to FIG. 2. In some cases, associating a region with the FBO may include inserting the region into an FBO queue (e.g., an ordered FBO list, an order FBO pool).

At 325, a state (e.g., mode) of the memory system 110 may be determined. For example, the memory system 110 may determine the state. In some cases, the ASIC 215, the memory system controller 115, the NAND controller, or other circuitry of the memory system 110 may determine the state of the memory system 110. For example, the state may be an active state, an idle state (e.g., level 2 (LV2) operation, low power state), or another state. In some cases, the memory system 110 may determine whether the memory system 110, the host system 105, or both, are in an idle state.

At 330, if the memory system 110 is in the idle state, an FBO associated with the selected region(s) may be performed. For example, the memory system 110 may perform the FBO. In some cases, the ASIC 215, the memory system controller 115, the NAND controller, or other circuitry of the memory system 110 may perform the FBO on the associated regions. In some cases, the FBO (e.g., file-based relocation operation) may be described in and performed in accordance with a memory standard (e.g., a Joint Electron Device Engineering Counsel (JEDEC) standard, a Universal Flash Storage (UFS) standard). In some cases, the FBO may include rewriting, at the memory system 110, data of one or more files associated with a selected region to respective consecutive physical addresses of the memory system 110, where at least a portion of the data may be stored in the region. In some cases, the FBO may be performed as a background operation during the idle state (e.g., an idle duration) of the memory system 110.

At 335, whether the FBO has been performed for all associated regions may be determined. For example, the memory system 110 may determine whether the FBO has been performed for all regions in the FBO queue. In some cases, the ASIC 215, the memory system controller 115, the NAND controller, or other circuitry of the memory system 110 may make the determination. If the FBO has been performed for all of the regions in the FBO queue, the memory system 110 may return to 305 and receive more commands. Alternatively, if the FBO has not been performed for all of the regions in the FBO queue, the memory system 110 may return to 325 to determine if the memory system 110 is still in the idle state.

At 340, whether a combined size of the regions associated with the FBO satisfy a threshold size may be determined. For example, the memory system 110 may determine whether the storage space included in the regions associated with the FBO (e.g., a first quantity of bytes) satisfy the threshold size (e.g., 40 gigabytes (GB)). In some cases, the ASIC 215, the memory system controller 115, the NAND controller, or other circuitry of the memory system 110 may determine whether the combined size of the regions associated with the FBO satisfy the threshold. Additionally, or alternatively, the memory system 110 may determine whether the size of combined size of the regions (e.g., a size of the FBO queue) satisfy the threshold size prior to performing the FBO at 330 of the memory system 110 is in the idle state. If the combined size of the regions associated with the FBO do not satisfy the threshold, the memory system 110 may return to 325 to determine whether the memory system 110 is in an idle state, or may return to 305 to receive more commands if the host system 105 is sending more commands to the memory system 110.

At 345, if the combined size of the regions associated with the FBO satisfy the threshold, FBO information (e.g., FBO information 265) may be transmitted. For example, the memory system 110 may transmit the FBO information to the host system 105. In some cases, the ASIC 215, the memory system controller 115, the NAND controller, or other circuitry of the memory system 110 may transmit the FBO information. In some cases, the FBO information may include an FBO recommendation flag indicating that the memory system 110 recommends or requests to perform FBO and an indication of one or more regions selected and associated with the FBO at 320. Additionally, or alternatively, the FBO information may include an urgency level associated with performing the FBO, which may be determined in accordance with the respective quantities and the region scatter factor.

At 350, whether the memory system 110 received an FBO command in response to the FBO information may be determined. For example, the memory system 110 may determine if the FBO command was received from the host system 105. In some cases, the ASIC 215, the memory system controller 115, the NAND controller, or other circuitry of the memory system 110 may determine if the FBO command was received. For example, the FBO command may be a command to perform the FBO associated with one or more of the indicated region. In some cases, the host system 105 may send the FBO command to the memory system 110 in response to the indicated urgency level being above a threshold urgency level. If the memory system 110 has not received the FBO command from the host system 105, the memory system 110 may retransmit the FBO information at 345 after a duration, or may return to 325 to determine whether the memory system 110 is in an idle state, or may return to 305 to receive more commands if the host system 105 is sending more commands to the memory system 110.

At 355, the FBO associated with one or more of the indicated regions may be performed. For example, the memory system 110 may perform the FBO. In some cases, In some cases, the ASIC 215, the memory system controller 115, the NAND controller, or other circuitry of the memory system 110 may perform the FBO. In some cases, the memory system 110 may perform the FBO during an active state of the memory system 110 in response to receiving the FBO command. Additionally, or alternatively, the memory system 110 may perform the FBO operation as a background operation during an idle duration of the memory system 110 after receiving the FBO command.

In some cases, at 360, FBO information (e.g., FBO information 260) may be received. For example, the memory system 110 may receive the FBO information from the host system 105. In some cases, the ASIC 215, the memory system controller 115, the NAND controller, or other circuitry of the memory system 110 may receive the FBO information from the host system 105. In some cases, the FBO information from the host system 105 may include an indication of a region to associate with the FBO, a region scatter factor associated with the region, an urgency level associated with the FBO, or a combination thereof. In some cases, the memory system 110 may perform the FBO operation at 355 (e.g., as a background operation, during the idle state, during the active state) for the region indicated in the FBO information from the host system 105 in response to receiving the FBO information.

In some cases, the memory system 110 may repeat one or more steps of the process 300. For example, the memory system 110 may receive, at 305, more commands for second access operations on more addresses of the memory system 110. At 310, the memory system 110 may determine, for each region (e.g., PPT2 region, PPT3 region) of the memory system 110, a respective second quantity of the second access operations performed in the region (e.g., a second hit count), and at least a subset of the second access operations may be performed in a region associated with a previous performance of FBO. Accordingly, at 320 and in accordance with the second respective quantities, the memory system 110 may select, to associate with a current FBO, a second region that is different from the region(s) associated with the previous performance of the FBO. Thus, the memory system 110 may cycle through more regions to further organize data in the memory system 110.

By performing the operations described in process 300, the memory system 110 may intelligently select regions for FBO, which may reduce a latency of operating the memory system 110.

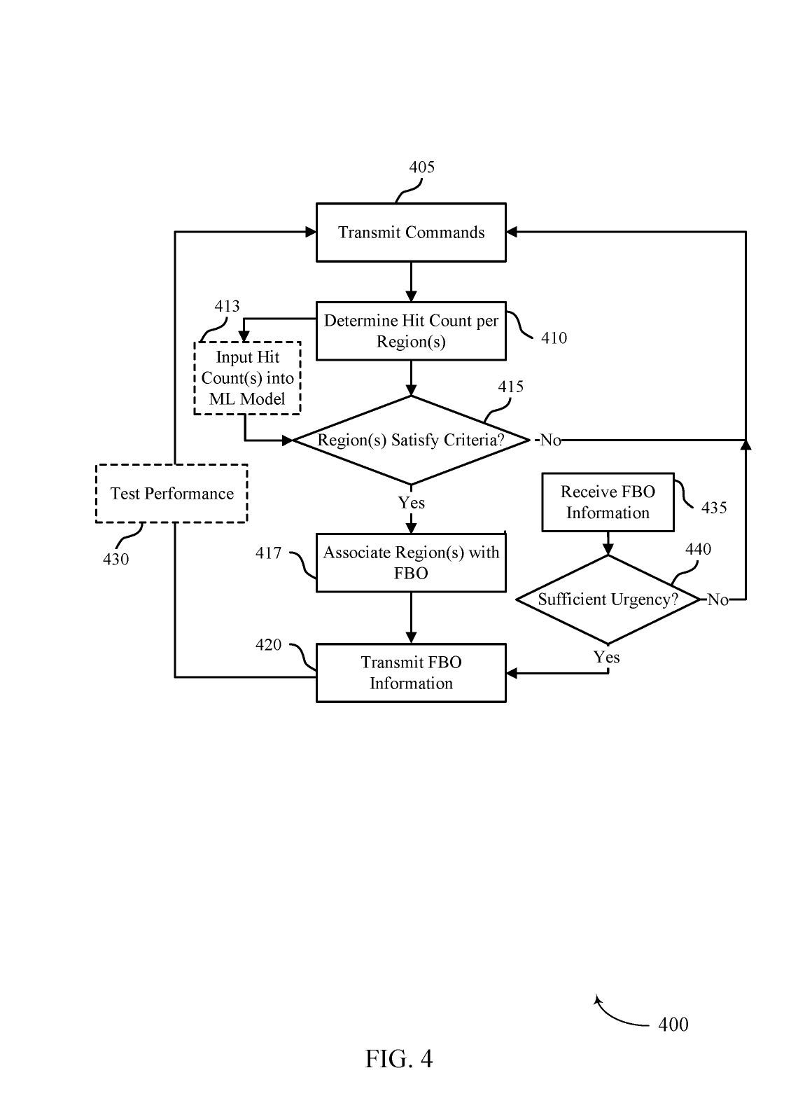

FIG. 4 shows an example of a process 400 that supports techniques for file-based data relocation at a memory system in accordance with examples as disclosed herein. In some cases, aspects of the process 400 may implement or be implemented by aspects of FIGS. 1-3. For example, the process 400 may be performed by the host system 105 or another component of the systems 100 and 200. In some aspects, the process 400 may illustrate an example algorithm that a host system 105 may perform to determine regions to book for FBO.

In the following description of the process 400, the operations may be performed in a different order than the order shown, or other operations may be added or removed from the process 400. For example, some operations may be left out of process 400, may be performed in different orders or at different times, or other operations may be added to process 400. Although a host system 105 may perform the operations of process 400, some aspects of some operations may also be performed by one or more other devices or components of the systems 100 and 200. Aspects of the process 400 may be implemented by one or more controllers (e.g., a host system controller 106), among other components. Additionally, or alternatively, aspects of the process 400 may be implemented as instructions stored in one or more memories (e.g., firmware stored in one or more memories coupled with a host system 105). For example, the instructions, when executed by one or more controllers (e.g., a host system controller 106), may cause the one or more controllers (or a device or a system) to perform the operations of the process 400.

At 405, one or more commands for access operations on a plurality of physical addresses of a memory system 110 may be transmitted. For example, a host system 105 may transmit the one or more commands to a memory system 110. In some cases, a host system controller 106 or other circuitry of the host system 105 may transmit the one or more commands. In some cases, the multiple access operations may include one or more read operations, write operations, unmap operations, or one or more memory operations.

At 410, a respective quantity of the access operations performed in each region of the memory system 110 may be determined. For example, the host system 105 may determine the respective quantities of access operations. In some cases, the host system controller 106 or other circuitry of the host system 105 may determine the respective quantities of the access operation. In some cases, for each region, the host system 105 may determine a first quantity of read operations, a second quantity of write operations, and a third quantity of unmap operations performed within the region. In some cases, the host system 105 may store the first quantity, second quantity, and third quantity, for each region, in a table at the host system 105 or another storage

Additionally, or alternatively, the host system 105 may receive an indication of the respective quantities of the access operations performed in each region. For example, the memory system 110 may determine the respective quantities of the access operations and may indicate the respective quantities to the host system 105.

At 413, the respective quantities of the access operations determined for the regions of the memory system 110 may be input into an ML model associated with FBO. For example, the host system 105 may input the respective quantities into the ML model, such as described at 313 of FIG. 3. In some cases, the host system controller 106 or other circuitry of the host system 105 may input the respective quantities into the ML model.

At 415, whether one or more regions satisfy one or more criteria may be determined. For example, the host system 105 may determine if one or more regions satisfy one or more criteria in accordance with the respective quantities. In some cases, the host system controller 106 or other circuitry of the host system 105 may determine whether one or more regions satisfy the one or more criteria. In some cases, the one or more criteria may include those described at 315 of FIG. 3 and others described herein.

At 417, a set of address regions to associate with the FBO may be determined. For example, the host system 105 may select one or more regions and associate the one or more regions with the FBO. In some cases, the host system controller 106 or other circuitry of the host system 105 may select and associate the one or more regions with the FBO. As described herein (e.g., with respect to 320 of FIG. 3), the one or more regions may be selected and associated with the FBO by the host system 105 in accordance with the respective quantities, the one or more criteria, and the output of the ML model.

At 420, FBO information (e.g., the FBO information 260) may be transmitted. For example, the host system 105 may transmit the FBO information to the memory system 110. In some cases, the host system controller 106 or other circuitry of the host system 105 may transmit the FBO information to the memory system 110. In some cases, the FBO information from the host system 105 may include an indication of one or more regions to associate with the FBO, an indication of an urgency level associated with performing the FBO, an indication of a region scatter factor associated with the one or more indicated regions (e.g., a comparison between a quantity of regions of the memory system 110 in which at least one of the access operations is performed and a total quantity of the access operations), or any combination thereof. In some cases, the FBO information may command the memory system 110 to perform FBO during an active state of the memory system 110 or during an idle state of the memory system 110.

At 430, a performance of the memory system 110 may be tested. For example, the host system 105 may test the performance of the memory system 110. In some cases, the host system controller 106 or other circuitry of the host system 105 may test the performance of the memory system 110. In some cases, to test the performance of the memory system 110, the host system 105 may transmit a quantity or commands (e.g., read commands) and determine a time used to complete the quantity of commands. In some cases, the host system 105 may measure one or more other metrics of the memory system 110 after transmitting the quantity of commands. In some cases, determining a relatively poor performance may cause the host system 105 to update one or more parameters for selecting regions for FBO that are more aggressive, such as selecting a larger quantity of regions for FBO, using fewer criteria or less strict criteria for selecting regions, or another update.

In some cases, the host system 105 may determine whether the FBO is finished before testing the performance of the memory system 110. In some cases, the host system 105 may transmit a get status command for the FBO at the memory system 110, and the memory system 110 may indicate a status of the FBO to the host system 105. In some cases, the status may indicate whether the FBO has started, if the FBO is currently occurring, if an error occurred in the FBO, or if the FBO is finished (e.g., has been performed for all of the regions indicated in an FBO queue). if the FBO is not finished, the host system 105 may wait for the FBO to finish. If the FBO is in error, the host system 105 may retransmit the FBO information. If the FBO is finished, the host system 105 may continue to 405 (e.g., or 430)

In some cases, at 435, FBO information (e.g., the FBO information 265) may be received. For example, the host system 105 may receive the FBO information from the memory system 110. In some cases, the host system controller 106 or other circuitry of the host system 105 may receive the FBO information. In some cases, the FBO information may include an indication of an FBO recommendation flag, one or more regions for which to perform FBO, an urgency level associated with performing the FBO, or any combination thereof.

At 440, whether the indicated urgency level satisfies a threshold urgency level may be determined. For example, the host system 105 may determine if the urgency level satisfies the threshold urgency level. In some cases, the host system controller 106 or other circuitry of the host system 105 may determine if the indicated urgency level satisfies the threshold urgency level. If the indicated urgency level satisfies the threshold urgency level, the host system may continue to 420 and transmit the FBO information to the memory system 110. If the indicated urgency level does not satisfy the threshold urgency level, the host system 105 may return to 405.

In some cases, the host system 105 may repeat one or more operations of the process 400. For example, the host system 105 may transmit, at 405, a one or more second commands for second access operations on the addresses of the memory system 110. The host system 105 may determine, at 410 and for each region of the memory system 110, a respective second quantity of the second access operations performed in the region, where at least a subset of the second access operations may be performed in a region associated with a previously performed FBO. In some cases, the host system 105 may transmit, at 420 and as a function of the respective second quantities of the second access operations determined for the regions, an indication of a second region to associate with FBO, where the second region may be different from the region associated with the previous FBO. Accordingly, the host system 105 may select varying regions to organize more data within the memory system 110.

By performing the operations described with respect to the process 400, the host system 105 may intelligently select regions of a memory system 110 to associated with FBO, which may more quickly organize data within the memory system 110 and reduce latency associated with performing operations at the memory system 110.

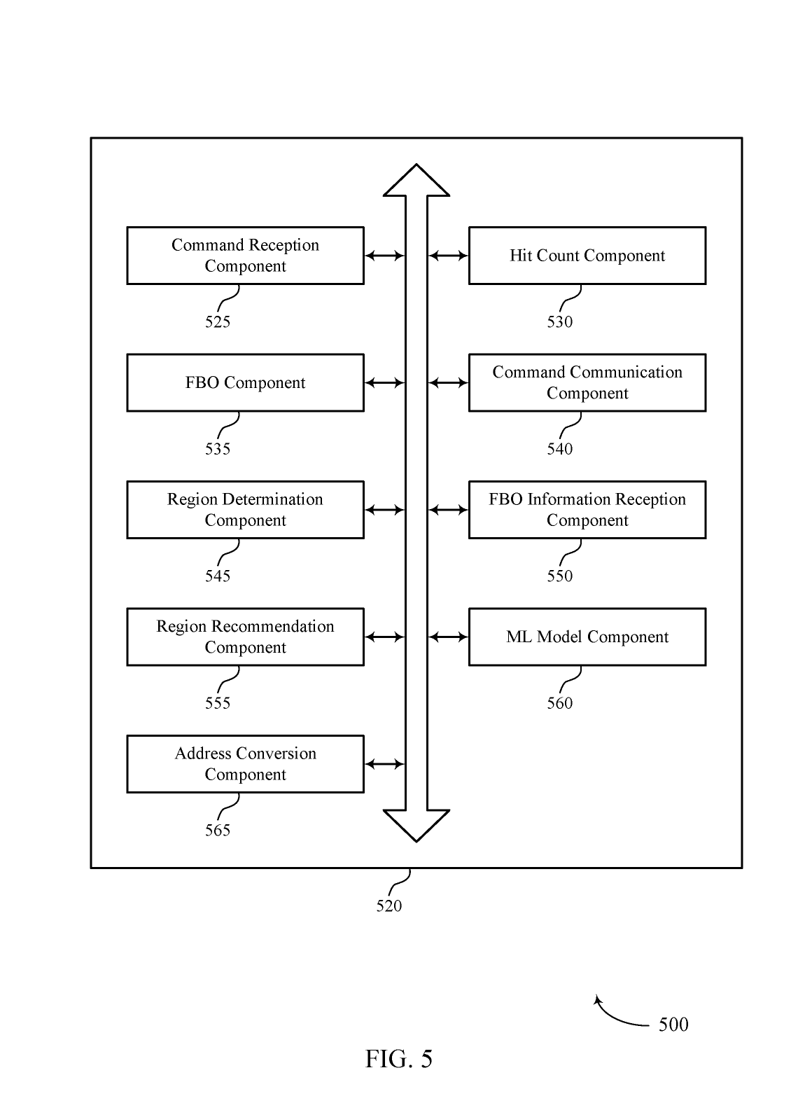

FIG. 5 shows a block diagram 500 of a memory system 520 that supports techniques for file-based data relocation at a memory system in accordance with examples as disclosed herein. The memory system 520 may be an example of aspects of a memory system as described with reference to FIGS. 1-4. The memory system 520, or various components thereof, may be an example of means for performing (e.g., to cause the memory system 520 to perform) various aspects of techniques for file-based data relocation at a memory system as described herein. For example, the memory system 520 may include a command reception component 525, a hit count component 530, an FBO component 535, a command communication component 540, a region determination component 545, an FBO information reception component 550, a region recommendation component 555, an ML model component 560, an address conversion component 565, or any combination thereof. Each of these components, or components of subcomponents thereof (e.g., one or more processors, one or more memories), may communicate, directly or indirectly, with one another (e.g., via one or more buses).

The memory system 520 may support operations in accordance with examples as disclosed herein. The command reception component 525 may be configured as or otherwise support a means for receiving, at the memory system 520, a plurality of commands for access operations on a plurality of addresses of the memory system 520. The hit count component 530 may be configured as or otherwise support a means for determining, at the memory system 520 and for each address region of a plurality of address regions of the memory system 520, a respective quantity of the access operations performed in the address region. The FBO component 535 may be configured as or otherwise support a means for performing, at the memory system 520, a file-based relocation operation associated with a first address region of the plurality of address regions as a function of the respective quantity of the access operations performed in the first address region.

In some examples, to support determining, for each address region, the respective quantity of the access operations, the hit count component 530 may be configured as or otherwise support a means for determining a first quantity of read operations, a second quantity of write operations, and a third quantity of unmap operations performed within the address region.

In some examples, performing the file-based relocation operation is in response to each of the first quantity of read operations, the second quantity of write operations, and the third quantity of unmap operations performed within the first address region satisfying a threshold.

In some examples, performing the file-based relocation operation is in response to a quantity of read operations of the respective quantity of the access operations performed in the first address region satisfying a threshold.

In some examples, performing the file-based relocation operation is in response to a combined quantity of write operations and unmap operations of the respective quantity of the access operations performed in the first address region satisfying a threshold.

In some examples, the region determination component 545 may be configured as or otherwise support a means for determining a set of address regions associated with the plurality of commands and including the first address region, where the set of address regions is determined in accordance with the respective quantity of the access operations determined for each address region.

In some examples, the FBO information reception component 550 may be configured as or otherwise support a means for receiving, at the memory system 520, an indication of the first address region, a region scatter factor associated with the first address region, an urgency level associated with the file-based relocation operation, or a combination thereof. In some examples, the FBO component 535 may be configured as or otherwise support a means for performing the file-based relocation operation in accordance with the indication.

In some examples, the command reception component 525 may be configured as or otherwise support a means for receiving, at the memory system 520, a second plurality of commands for second access operations on the plurality of addresses of the memory system 520. In some examples, the hit count component 530 may be configured as or otherwise support a means for determining, at the memory system 520 and for each address region of the plurality of address regions, a respective second quantity of the second access operations performed in the address region, where at least a subset of the second access operations are performed in the first address region. In some examples, the region determination component 545 may be configured as or otherwise support a means for selecting, to associate with the file-based relocation operation, a second address region that is different from the first address region as a function of the first address region being associated with the file-based relocation operation.

In some examples, performing the file-based relocation operation is in response to a storage size of an ordered set of address regions associated with the file-based relocation operation satisfying a threshold storage size.

In some examples, the file-based relocation operation associated with the first address region is performed as a background operation during an idle duration of the memory system 520.

In some examples, the region recommendation component 555 may be configured as or otherwise support a means for transmitting, from the memory system 520 as a function of the respective quantity of the access operations performed in the first address region, an indication of the first address region. In some examples, the FBO information reception component 550 may be configured as or otherwise support a means for receiving, at the memory system 520 in response to the indication of the first address region, a command to perform the file-based relocation operation associated with the first address region, where the file-based relocation operation associated with the first address region is performed in accordance with the command.

In some examples, the indication of the first address region includes an urgency level associated with performing the file-based relocation operation.

In some examples, the ML model component 560 may be configured as or otherwise support a means for inputting the respective quantity of the access operations determined for each address region into a machine learning model associated with the file-based relocation operation, where the first address region is associated with the file-based relocation operation in accordance with an output of the machine learning model.

In some examples, the address conversion component 565 may be configured as or otherwise support a means for converting a plurality of logical addresses indicated by the plurality of commands into the plurality of addresses in accordance with a logical to physical mapping at the memory system 520, where the respective quantity of the access operations are determined for each address region as a function of the converting.

In some examples, the file-based relocation operation includes an FBO operation in accordance with a memory standard.

In some examples, to support performing the file-based relocation operation, the FBO component 535 may be configured as or otherwise support a means for rewriting, at the memory system 520, data of one or more files associated with the first address region to respective consecutive addresses of the memory system 520, where at least a portion of the data is stored in the first address region.

Additionally, or alternatively, the memory system 520 may support operations in accordance with examples as disclosed herein. The command communication component 540 may be configured as or otherwise support a means for communicating a plurality of commands for access operations on a plurality of addresses of the memory system 520. The region determination component 545 may be configured as or otherwise support a means for selecting, as a function of a respective quantity of the access operations performed on a first address region of a plurality of address regions, the first address region to associate with a file-based relocation operation.

In some examples, the hit count component 530 may be configured as or otherwise support a means for determining, at the memory system 520 and for each address region of the plurality of address regions, the respective quantity of the access operations performed in the address region, where the first address region is selected in response to the determining.

In some examples, the FBO information reception component 550 may be configured as or otherwise support a means for receiving, at the memory system 520, an indication of respective quantities of the access operations performed in each address region of the plurality of address regions, where the first address region is selected in response to receiving the indication of the respective quantities of the access operations.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the memory system 520 to perform one or more operations. In some examples, the described functionality of the memory system 520, or various components thereof, may be implemented at least in part by instructions (e.g., stored in memory, non-transitory computer-readable medium) executable by such at least one processor to cause the memory system 520 to perform one or more operations.

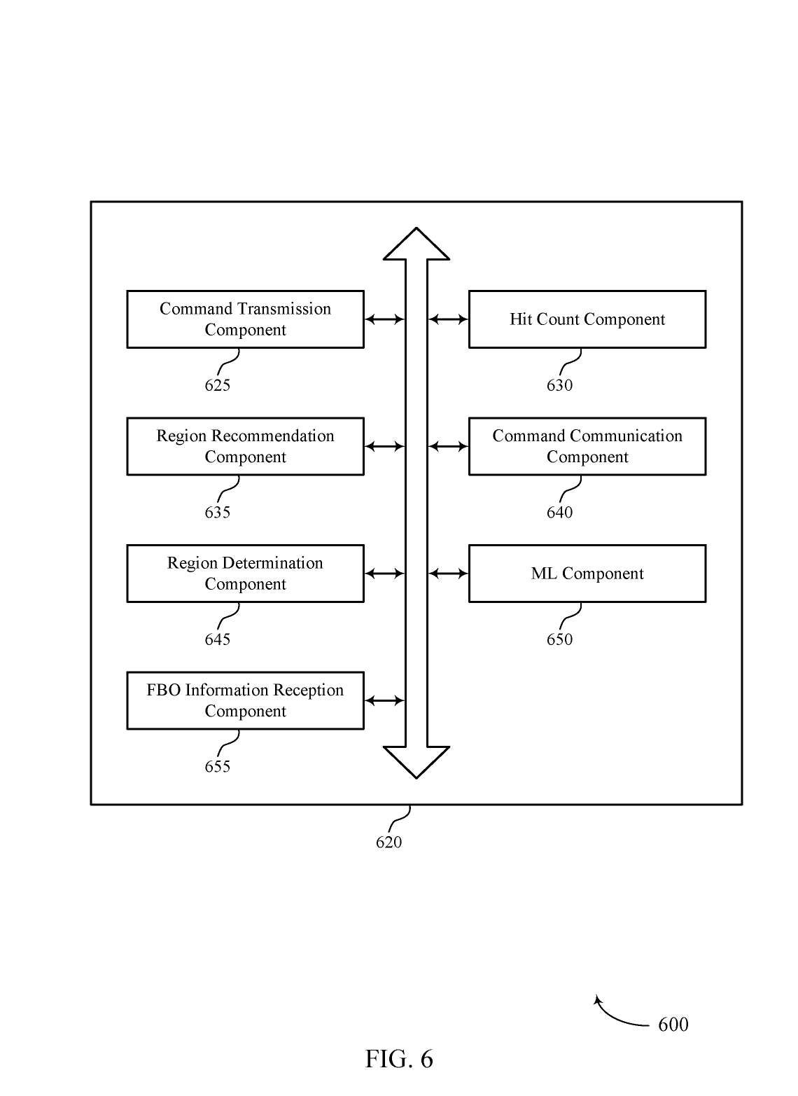

FIG. 6 shows a block diagram 600 of a host system 620 that supports techniques for file-based data relocation at a memory system in accordance with examples as disclosed herein. The host system 620 may be an example of aspects of a host system as described with reference to FIGS. 1-4. The host system 620, or various components thereof, may be an example of means for performing (e.g., to cause the host system 620 to perform) various aspects of techniques for file-based data relocation at a memory system as described herein. For example, the host system 620 may include a command transmission component 625, a hit count component 630, a region recommendation component 635, a command communication component 640, a region determination component 645, an ML component 650, an FBO information reception component 655, or any combination thereof. Each of these components, or components of subcomponents thereof (e.g., one or more processors, one or more memories), may communicate, directly or indirectly, with one another (e.g., via one or more buses).

The host system 620 may support operations in accordance with examples as disclosed herein. The command transmission component 625 may be configured as or otherwise support a means for transmitting, from the host system 620, a plurality of commands for access operations on a plurality of addresses of a memory system. The hit count component 630 may be configured as or otherwise support a means for determining, at the host system 620 and for each address region of a plurality of address regions of the memory system, a respective quantity of the access operations performed in the address region. The region recommendation component 635 may be configured as or otherwise support a means for transmitting, from the host system 620 as a function of the respective quantity of the access operations performed on a first address region of the plurality of address regions, an indication of the first address region to associate with a file-based relocation operation.

In some examples, to support determining, for each address region, the respective quantity of the access operations, the hit count component 630 may be configured as or otherwise support a means for determining a first quantity of read operations, a second quantity of write operations, and a third quantity of unmap operations performed within the address region.

In some examples, transmitting the indication of the first address region to associate with the file-based relocation operation is in response to each of the first quantity of read operations, the second quantity of write operations, and the third quantity of unmap operations performed within the first address region satisfying a threshold.

In some examples, transmitting the indication of the first address region to associate with the file-based relocation operation is in response to a quantity of read operations of the respective quantity of the access operations performed in the first address region satisfying a threshold.

In some examples, transmitting the indication of the first address region to associate with the file-based relocation operation is in response to a combined quantity of write operations and unmap operations of the respective quantity of the access operations performed in the first address region satisfying a threshold.

In some examples, the region recommendation component 635 may be configured as or otherwise support a means for transmitting, with the indication of the first address region, an indication of an urgency level associated with performing the file-based relocation operation.

In some examples, the region recommendation component 635 may be configured as or otherwise support a means for transmitting, with the indication of the first address region, an indication of a region scatter factor, the region scatter factor associated with a comparison between a quantity of address regions of the memory system in which at least one of the access operations is performed and a total quantity of the access operations.

In some examples, the region determination component 645 may be configured as or otherwise support a means for determining a set of address regions associated with the plurality of commands and including the first address region, where the set of address regions is determined in accordance with the respective quantity of the access operations determined for each address region.

In some examples, the command transmission component 625 may be configured as or otherwise support a means for transmitting, from the host system 620, a second plurality of commands for second access operations on the plurality of addresses of the memory system. In some examples, the hit count component 630 may be configured as or otherwise support a means for determining, at the host system 620 and for each address region of the plurality of address regions, a respective second quantity of the second access operations performed in the address region, where at least a subset of the second access operations are performed in the first address region. In some examples, the region recommendation component 635 may be configured as or otherwise support a means for transmitting, as a function of the respective second quantity of the second access operations determined for each address region, an indication of a second address region to associate with the file-based relocation operation, where the second address region is different from the first address region as a function of the first address region being associated with the file-based relocation operation.

In some examples, the ML component 650 may be configured as or otherwise support a means for inputting the respective quantity of the access operations determined for each address region into a machine learning model associated with the file-based relocation operation, where the indication of the first address region is transmitted in accordance with an output of the machine learning model.

In some examples, the file-based relocation operation includes an FBO operation in accordance with a memory standard.

Additionally, or alternatively, the host system 620 may support operations in accordance with examples as disclosed herein. The command communication component 640 may be configured as or otherwise support a means for communicating a plurality of commands for access operations on a plurality of addresses of a memory system. The region determination component 645 may be configured as or otherwise support a means for selecting, as a function of a respective quantity of the access operations performed on a first address region of a plurality of address regions, the first address region to associate with a file-based relocation operation.

In some examples, the hit count component 630 may be configured as or otherwise support a means for determining, at the host system 620 and for each address region of the plurality of address regions, the respective quantity of the access operations performed in the address region, where the first address region is selected in response to the determining.

In some examples, the FBO information reception component 655 may be configured as or otherwise support a means for receiving, at the host system 620, an indication of respective quantities of the access operations performed in each address region of the plurality of address regions, where the first address region is selected in response to receiving the indication of the respective quantities of the access operations.

In some examples, the described functionality of the host system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the host system 620 to perform one or more operations. In some examples, the described functionality of the host system 620, or various components thereof, may be implemented at least in part by instructions (e.g., stored in memory, non-transitory computer-readable medium) executable by such at least one processor to cause the host system 620 to perform one or more operations.

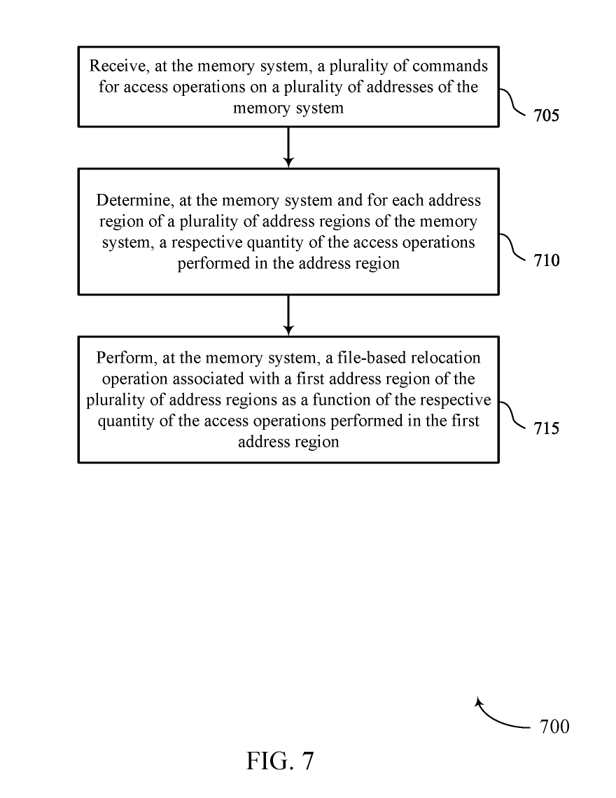

FIG. 7 shows a flowchart illustrating a method 700 that supports techniques for file-based data relocation at a memory system in accordance with examples as disclosed herein. The operations of method 700 may be implemented by a memory system or its components as described herein. For example, the operations of method 700 may be performed by a memory system as described with reference to FIGS. 1-5. In some examples, a memory system may execute a set of instructions to control the functional elements of the device to perform the described functions. Additionally, or alternatively, the memory system may perform aspects of the described functions using special-purpose hardware.

At 705, the method 700 may include receiving, at a memory system, a plurality of commands for access operations on a plurality of addresses of the memory system. In some examples, aspects of the operations of 705 may be performed by a command reception component 525.

At 710, the method 700 may include determining, at the memory system and for each address region of a plurality of address regions of the memory system, a respective quantity of the access operations performed in the address region. In some examples, aspects of the operations of 710 may be performed by a hit count component 530.

At 715, the method 700 may include performing, at the memory system, a file-based relocation operation associated with a first address region of the plurality of address regions as a function of the respective quantity of the access operations performed in the first address region. In some examples, aspects of the operations of 715 may be performed by an FBO component 535.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at the memory system, a plurality of commands for access operations on a plurality of addresses of the memory system; determining, at the memory system and for each address region of a plurality of address regions of the memory system, a respective quantity of the access operations performed in the address region; and performing, at the memory system, a file-based relocation operation associated with a first address region of the plurality of address regions as a function of the respective quantity of the access operations performed in the first address region.

Aspect 2: The method, apparatus, or non-transitory computer-readable medium of aspect 1, where determining, for each address region, the respective quantity of the access operations includes operations, features, circuitry, logic, means, or instructions, or any combination thereof for determining a first quantity of read operations, a second quantity of write operations, and a third quantity of unmap operations performed within the address region.

Aspect 3: The method, apparatus, or non-transitory computer-readable medium of aspect 2, where performing the file-based relocation operation is in response to each of the first quantity of read operations, the second quantity of write operations, and the third quantity of unmap operations performed within the first address region satisfying a threshold.

Aspect 4: The method, apparatus, or non-transitory computer-readable medium of any of aspects 1 through 3, where performing the file-based relocation operation is in response to a quantity of read operations of the respective quantity of the access operations performed in the first address region satisfying a threshold.

Aspect 5: The method, apparatus, or non-transitory computer-readable medium of any of aspects 1 through 4, where performing the file-based relocation operation is in response to a combined quantity of write operations and unmap operations of the respective quantity of the access operations performed in the first address region satisfying a threshold.

Aspect 6: The method, apparatus, or non-transitory computer-readable medium of any of aspects 1 through 5, further including operations, features, circuitry, logic, means, or instructions, or any combination thereof for determining a set of address regions associated with the plurality of commands and including the first address region, where the set of address regions is determined in accordance with the respective quantity of the access operations determined for each address region.

Aspect 7: The method, apparatus, or non-transitory computer-readable medium of any of aspects 1 through 6, further including operations, features, circuitry, logic, means, or instructions, or any combination thereof for receiving, at the memory system, an indication of the first address region, a region scatter factor associated with the first address region, an urgency level associated with the file-based relocation operation, or a combination thereof and performing the file-based relocation operation in accordance with the indication.

Aspect 8: The method, apparatus, or non-transitory computer-readable medium of any of aspects 1 through 7, further including operations, features, circuitry, logic, means, or instructions, or any combination thereof for receiving, at the memory system, a second plurality of commands for second access operations on the plurality of addresses of the memory system; determining, at the memory system and for each address region of the plurality of address regions, a respective second quantity of the second access operations performed in the address region, where at least a subset of the second access operations are performed in the first address region; and selecting, to associate with the file-based relocation operation, a second address region that is different from the first address region as a function of the first address region being associated with the file-based relocation operation.

Aspect 9: The method, apparatus, or non-transitory computer-readable medium of any of aspects 1 through 8, where performing the file-based relocation operation is in response to a storage size of an ordered set of address regions associated with the file-based relocation operation satisfying a threshold storage size.

Aspect 10: The method, apparatus, or non-transitory computer-readable medium of any of aspects 1 through 9, where the file-based relocation operation associated with the first address region is performed as a background operation during an idle duration of the memory system.

Aspect 11: The method, apparatus, or non-transitory computer-readable medium of any of aspects 1 through 10, further including operations, features, circuitry, logic, means, or instructions, or any combination thereof for transmitting, from the memory system as a function of the respective quantity of the access operations performed in the first address region, an indication of the first address region and receiving, at the memory system in response to the indication of the first address region, a command to perform the file-based relocation operation associated with the first address region, where the file-based relocation operation associated with the first address region is performed in accordance with the command.

Aspect 12: The method, apparatus, or non-transitory computer-readable medium of aspect 11, where the indication of the first address region includes an urgency level associated with performing the file-based relocation operation.

Aspect 13: The method, apparatus, or non-transitory computer-readable medium of any of aspects 1 through 12, further including operations, features, circuitry, logic, means, or instructions, or any combination thereof for inputting the respective quantity of the access operations determined for each address region into a machine learning model associated with the file-based relocation operation, where the first address region is associated with the file-based relocation operation in accordance with an output of the machine learning model.

Aspect 14: The method, apparatus, or non-transitory computer-readable medium of any of aspects 1 through 13, further including operations, features, circuitry, logic, means, or instructions, or any combination thereof for converting a plurality of logical addresses indicated by the plurality of commands into the plurality of addresses in accordance with a logical to physical mapping at the memory system, where the respective quantity of the access operations are determined for each address region as a function of the converting.

Aspect 15: The method, apparatus, or non-transitory computer-readable medium of any of aspects 1 through 14, where the file-based relocation operation includes an FBO operation in accordance with a memory standard.

Aspect 16: The method, apparatus, or non-transitory computer-readable medium of any of aspects 1 through 15, where performing the file-based relocation operation includes operations, features, circuitry, logic, means, or instructions, or any combination thereof for rewriting, at the memory system, data of one or more files associated with the first address region to respective consecutive addresses of the memory system, where at least a portion of the data is stored in the first address region.

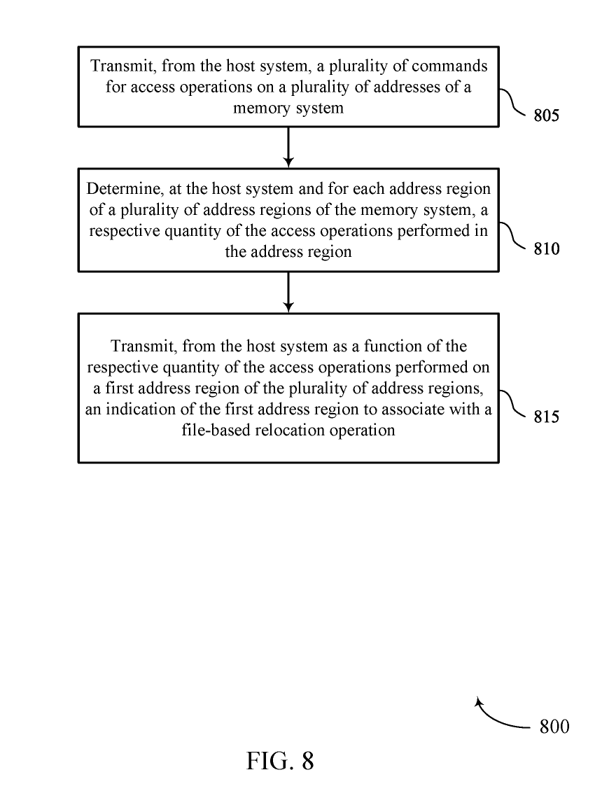

FIG. 8 shows a flowchart illustrating a method 800 that supports techniques for file-based data relocation at a memory system in accordance with examples as disclosed herein. The operations of method 800 may be implemented by a host system or its components as described herein. For example, the operations of method 800 may be performed by a host system as described with reference to FIGS. 1-4 and 6. In some examples, a host system may execute a set of instructions to control the functional elements of the device to perform the described functions. Additionally, or alternatively, the host system may perform aspects of the described functions using special-purpose hardware.

At 805, the method 800 may include transmitting, from a host system, a plurality of commands for access operations on a plurality of addresses of a memory system. In some examples, aspects of the operations of 805 may be performed by a command transmission component 625.

At 810, the method 800 may include determining, at the host system and for each address region of a plurality of address regions of the memory system, a respective quantity of the access operations performed in the address region. In some examples, aspects of the operations of 810 may be performed by a hit count component 630.

At 815, the method 800 may include transmitting, from the host system as a function of the respective quantity of the access operations performed on a first address region of the plurality of address regions, an indication of the first address region to associate with a file-based relocation operation. In some examples, aspects of the operations of 815 may be performed by a region recommendation component 635.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 17: A method, apparatus, or non-transitory computer-readable medium including operations, features, circuitry, logic, means, or instructions, or any combination thereof for transmitting, from the host system, a plurality of commands for access operations on a plurality of addresses of a memory system; determining, at the host system and for each address region of a plurality of address regions of the memory system, a respective quantity of the access operations performed in the address region; and transmitting, from the host system as a function of the respective quantity of the access operations performed on a first address region of the plurality of address regions, an indication of the first address region to associate with a file-based relocation operation.

Aspect 18: The method, apparatus, or non-transitory computer-readable medium of aspect 17, where determining, for each address region, the respective quantity of the access operations includes operations, features, circuitry, logic, means, or instructions, or any combination thereof for determining a first quantity of read operations, a second quantity of write operations, and a third quantity of unmap operations performed within the address region.

Aspect 19: The method, apparatus, or non-transitory computer-readable medium of any of aspects 17 through 18, where transmitting the indication of the first address region to associate with the file-based relocation operation is in response to each of the first quantity of read operations, the second quantity of write operations, and the third quantity of unmap operations performed within the first address region satisfying a threshold.

Aspect 20: The method, apparatus, or non-transitory computer-readable medium of any of aspects 17 through 19, where transmitting the indication of the first address region to associate with the file-based relocation operation is in response to a quantity of read operations of the respective quantity of the access operations performed in the first address region satisfying a threshold.

Aspect 21: The method, apparatus, or non-transitory computer-readable medium of any of aspects 17 through 20, where transmitting the indication of the first address region to associate with the file-based relocation operation is in response to a combined quantity of write operations and unmap operations of the respective quantity of the access operations performed in the first address region satisfying a threshold.

Aspect 22: The method, apparatus, or non-transitory computer-readable medium of any of aspects 17 through 21, further including operations, features, circuitry, logic, means, or instructions, or any combination thereof for transmitting, with the indication of the first address region, an indication of an urgency level associated with performing the file-based relocation operation.

Aspect 23: The method, apparatus, or non-transitory computer-readable medium of any of aspects 17 through 22, further including operations, features, circuitry, logic, means, or instructions, or any combination thereof for transmitting, with the indication of the first address region, an indication of a region scatter factor, the region scatter factor associated with a comparison between a quantity of address regions of the memory system in which at least one of the access operations is performed and a total quantity of the access operations.

Aspect 24: The method, apparatus, or non-transitory computer-readable medium of any of aspects 17 through 23, further including operations, features, circuitry, logic, means, or instructions, or any combination thereof for determining a set of address regions associated with the plurality of commands and including the first address region, where the set of address regions is determined in accordance with the respective quantity of the access operations determined for each address region.

Aspect 25: The method, apparatus, or non-transitory computer-readable medium of any of aspects 17 through 24, further including operations, features, circuitry, logic, means, or instructions, or any combination thereof for transmitting, from the host system, a second plurality of commands for second access operations on the plurality of addresses of the memory system; determining, at the host system and for each address region of the plurality of address regions, a respective second quantity of the second access operations performed in the address region, where at least a subset of the second access operations are performed in the first address region; and transmitting, as a function of the respective second quantity of the second access operations determined for each address region, an indication of a second address region to associate with the file-based relocation operation, where the second address region is different from the first address region as a function of the first address region being associated with the file-based relocation operation.

Aspect 26: The method, apparatus, or non-transitory computer-readable medium of any of aspects 17 through 25, further including operations, features, circuitry, logic, means, or instructions, or any combination thereof for inputting the respective quantity of the access operations determined for each address region into a machine learning model associated with the file-based relocation operation, where the indication of the first address region is transmitted in accordance with an output of the machine learning model.

Aspect 27: The method, apparatus, or non-transitory computer-readable medium of any of aspects 17 through 26, where the file-based relocation operation includes an FBO operation in accordance with a memory standard.

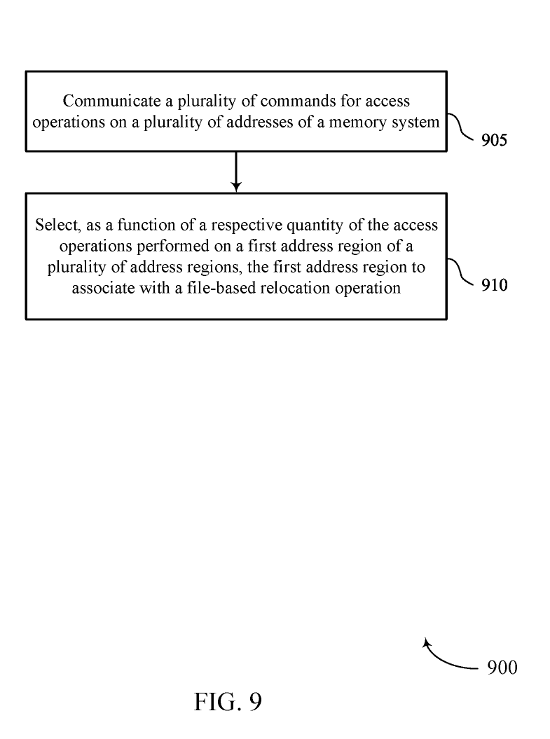

FIG. 9 shows a flowchart illustrating a method 900 that supports techniques for file-based data relocation at a memory system in accordance with examples as disclosed herein. The operations of method 900 may be implemented by a memory system or a host system or its components as described herein. For example, the operations of method 900 may be performed by a memory system as described with reference to FIGS. 1-5 or a host system as described with reference to FIGS. 1-4 and 6. In some examples, a memory system or a host system may execute a set of instructions to control the functional elements of the device to perform the described functions. Additionally, or alternatively, the memory system or the host system may perform aspects of the described functions using special-purpose hardware.

At 905, the method 900 may include communicating a plurality of commands for access operations on a plurality of addresses of a memory system. In some examples, aspects of the operations of 905 may be performed by a command communication component 540 or a command communication component 640.

At 910, the method 900 may include selecting, as a function of a respective quantity of the access operations performed on a first address region of a plurality of address regions, the first address region to associate with a file-based relocation operation. In some examples, aspects of the operations of 910 may be performed by a region determination component 545 or a region determination component 645.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 28: A method, apparatus, or non-transitory computer-readable medium including operations, features, circuitry, logic, means, or instructions, or any combination thereof for communicating a plurality of commands for access operations on a plurality of addresses of a memory system and selecting, as a function of a respective quantity of the access operations performed on a first address region of a plurality of address regions, the first address region to associate with a file-based relocation operation.

Aspect 29: The method, apparatus, or non-transitory computer-readable medium of aspect 28, further including operations, features, circuitry, logic, means, or instructions, or any combination thereof for determining, for each address region of the plurality of address regions, the respective quantity of the access operations performed in the address region, where the first address region is selected in response to the determining.

Aspect 30: The method, apparatus, or non-transitory computer-readable medium of any of aspects 28 through 29, further including operations, features, circuitry, logic, means, or instructions, or any combination thereof for receiving an indication of respective quantities of the access operations performed in each address region of the plurality of address regions, where the first address region is selected in response to receiving the indication of the respective quantities of the access operations.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit in accordance with the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive, at the memory system, a plurality of commands for access operations on a plurality of addresses of the memory system;
determine, at the memory system and for each address region of a plurality of address regions of the memory system, a respective quantity of the access operations performed in the address region; and
perform, at the memory system, a file-based relocation operation associated with a first address region of the plurality of address regions as a function of the respective quantity of the access operations performed in the first address region.

2. The memory system of claim 1, wherein, to determine, for each address region, the respective quantity of the access operations, the processing circuitry is configured to cause the memory system to:
determine a first quantity of read operations, a second quantity of write operations, and a third quantity of unmap operations performed within the address region.

3. The memory system of claim 2, wherein performing the file-based relocation operation is in response to each of the first quantity of read operations, the second quantity of write operations, and the third quantity of unmap operations performed within the first address region satisfying a threshold.

4. The memory system of claim 1, wherein performing the file-based relocation operation is in response to a quantity of read operations of the respective quantity of the access operations performed in the first address region satisfying a threshold.

5. The memory system of claim 1, wherein performing the file-based relocation operation is in response to a combined quantity of write operations and unmap operations of the respective quantity of the access operations performed in the first address region satisfying a threshold.

6. The memory system of claim 1, wherein the processing circuitry is further configured to cause the memory system to:
determine a set of address regions associated with the plurality of commands and comprising the first address region, wherein the set of address regions is determined in accordance with the respective quantity of the access operations determined for each address region.

7. The memory system of claim 1, wherein the processing circuitry is further configured to cause the memory system to:
receive, at the memory system, an indication of the first address region, a region scatter factor associated with the first address region, an urgency level associated with the file-based relocation operation, or a combination thereof; and
perform the file-based relocation operation in accordance with the indication.

8. The memory system of claim 1, wherein the processing circuitry is further configured to cause the memory system to:
receive, at the memory system, a second plurality of commands for second access operations on the plurality of addresses of the memory system;
determine, at the memory system and for each address region of the plurality of address regions, a respective second quantity of the second access operations performed in the address region, wherein at least a subset of the second access operations are performed in the first address region; and
select, to associate with the file-based relocation operation, a second address region that is different from the first address region as a function of the first address region being associated with the file-based relocation operation.

9. The memory system of claim 1, wherein performing the file-based relocation operation is in response to a storage size of an ordered set of address regions associated with the file-based relocation operation satisfying a threshold storage size.

10. The memory system of claim 1, wherein the file-based relocation operation associated with the first address region is performed as a background operation during an idle duration of the memory system.

11. The memory system of claim 1, wherein the processing circuitry is further configured to cause the memory system to:
transmit, from the memory system as a function of the respective quantity of the access operations performed in the first address region, an indication of the first address region and an urgency level associated with performing the file-based relocation operation; and
receive, at the memory system in response to the indication of the first address region and the urgency level, a command to perform the file-based relocation operation associated with the first address region, wherein the file-based relocation operation associated with the first address region is performed in accordance with the command.

12. The memory system of claim 1, wherein the processing circuitry is further configured to cause the memory system to:
input the respective quantity of the access operations determined for each address region into a machine learning model associated with the file-based relocation operation, wherein the first address region is associated with the file-based relocation operation in accordance with an output of the machine learning model.

13. The memory system of claim 1, wherein the file-based relocation operation comprises a file-based optimization (FBO) operation in accordance with a memory standard.

14. The memory system of claim 1, wherein, to perform the file-based relocation operation, the processing circuitry is configured to cause the memory system to:
rewrite, at the memory system, data of one or more files associated with the first address region to respective consecutive addresses of the memory system, wherein at least a portion of the data is stored in the first address region.

15. A host system, comprising:
one or more interfaces comprising one or more signal paths operable for communications with one or more memory systems; and
processing circuitry coupled with the one or more interfaces and configured to cause the host system to:
transmit, from the host system, a plurality of commands for access operations on a plurality of addresses of a memory system;
determine, at the host system and for each address region of a plurality of address regions of the memory system, a respective quantity of the access operations performed in the address region; and
transmit, from the host system as a function of the respective quantity of the access operations performed on a first address region of the plurality of address regions, an indication of the first address region to associate with a file-based relocation operation.

16. The host system of claim 15, wherein, to determine, for each address region, the respective quantity of the access operations, the processing circuitry is configured to cause the host system to:
determine a first quantity of read operations, a second quantity of write operations, and a third quantity of unmap operations performed within the address region.

17. The host system of claim 16, wherein transmitting the indication of the first address region to associate with the file-based relocation operation is in response to each of the first quantity of read operations, the second quantity of write operations, and the third quantity of unmap operations performed within the first address region satisfying a threshold.

18. The host system of claim 15, wherein transmitting the indication of the first address region to associate with the file-based relocation operation is in response to a quantity of read operations of the respective quantity of the access operations performed in the first address region satisfying a threshold.

19. The host system of claim 15, wherein transmitting the indication of the first address region to associate with the file-based relocation operation is in response to a combined quantity of write operations and unmap operations of the respective quantity of the access operations performed in the first address region satisfying a threshold.

20. The host system of claim 15, wherein the processing circuitry is further configured to cause the host system to:
transmit, with the indication of the first address region, an indication of a region scatter factor, the region scatter factor associated with a comparison between a quantity of address regions of the memory system in which at least one of the access operations is performed and a total quantity of the access operations.

21. The host system of claim 15, wherein the processing circuitry is further configured to cause the host system to:
transmit, from the host system, a second plurality of commands for second access operations on the plurality of addresses of the memory system;
determine, at the host system and for each address region of the plurality of address regions, a respective second quantity of the second access operations performed in the address region, wherein at least a subset of the second access operations are performed in the first address region; and
transmit, as a function of the respective second quantity of the second access operations determined for each address region, an indication of a second address region to associate with the file-based relocation operation, wherein the second address region is different from the first address region as a function of the first address region being associated with the file-based relocation operation.

22. A device, comprising:
processing circuitry associated with one or more memory devices and configured to cause the device to:
communicate a plurality of commands for access operations on a plurality of addresses of a memory system; and
select, as a function of a respective quantity of the access operations performed on a first address region of a plurality of address regions, the first address region to associate with a file-based relocation operation.

23. The device of claim 22, wherein the processing circuitry is further configured to cause the device to:
receive, at the device, an indication of respective quantities of the access operations performed in each address region of the plurality of address regions, wherein the first address region is selected in response to receiving the indication of the respective quantities of the access operations.
